(19) United States
(12) Patent Application Publication
(10) Pub. No.: US 2026/0132723 A1
(43) Pub. Date: May 14, 2026

(54) LUBRICATION RINGS FOR AIRCRAFT ENGINE BOLTS

(71) Applicant: Pratt & Whitney Canada Corp., Longueuil (CA)

(72) Inventor: RAGHUNATH NAGARAJ, Milton (CA)

(21) Appl. No.: 18/944,822

(22) Filed: Nov. 12, 2024

(51) Int. Cl. F01D 25/24; F01D 25/18

(52) U.S. Cl. CPC F01D 25/243; F01D 25/18; F05D 2220/323; F05D 2260/31; F05D 2260/98

(57) ABSTRACT

A method is provided during which lubrication material is arranged with a fastening member. The lubrication material is at a first temperature during the arranging of the lubrication material such that the lubrication material is solid and forms a self-supporting lubrication ring. The arranging of the lubrication material includes one of: mounting the self-supporting lubrication ring onto a shank of the fastening member; or mounting the self-supporting lubrication ring onto a surface defining an aperture such that the lubrication ring extends around the aperture. After the arranging of the lubrication material, the shank of the fastening member is inserted into the aperture.

### TECHNICAL FIELD

This disclosure relates generally to an aircraft engine and, more particularly, to assembling components of the aircraft engine together.

### BACKGROUND INFORMATION

Various methods are known in the art for assembling aircraft engine components together. While these known assembly methods have various benefits, there is still room in the art for improvement.

### SUMMARY

According to an aspect of the present disclosure, a method is provided during which lubrication material is arranged with a fastening member. The lubrication material is at a first temperature during the arranging of the lubrication material such that the lubrication material is solid and forms a self-supporting lubrication ring. The arranging of the lubrication material includes one of: mounting the self-supporting lubrication ring onto a shank of the fastening member; or mounting the self-supporting lubrication ring onto a surface defining an aperture such that the lubrication ring extends around the aperture. After the arranging of the lubrication material, the shank of the fastening member is inserted into the aperture.

According to another aspect of the present disclosure, another method is provided during which a temperature of a layer of lubrication material is controlled to be below a phase-change temperature associated with the lubrication material. The lubrication material is in a non-solid state when above the phase-change temperature and the lubrication material is in a solid state when below the phase-change temperature. A plurality of self-supporting lubrication rings are cut out of the layer of lubrication material while the layer of lubrication material is below the phase-change temperature. The self-supporting lubrication rings are gathered for further use while the self-supporting lubrication remains below the phase-change temperature.

According to still another aspect of the present disclosure, a method of manufacture is provided during which a self-supporting lubrication ring is formed out of a layer of lubrication material at or below a first temperature. The lubrication material is solid at the first temperature. The self-supporting lubrication ring is mounted onto a shank of a bolt. The self-supporting lubrication ring is axially abutted against a head of the bolt while the lubrication material is at the first temperature. The bolt is arranged with a first engine component and a second engine component such that the lubrication material is axially between the head of the bolt and the first engine component and the shank of the bolt is disposed in a first aperture of the first engine component and a second aperture of the second engine component. The head of the bolt is preloaded against the first engine component axially through the lubrication material. The lubrication material is at a second temperature that is higher than the first temperature during the preloading of the head of the bolt. The lubrication material is semi-solid at the second temperature.

The method may also include: threading a nut onto the shank of the bolt with the first engine component and the second engine component captured axially between the head of the bolt and the nut; and torquing the nut onto the bolt to preload the head of the bolt against the first engine component axially through the lubrication material.

The self-supporting lubrication ring may be formed while the layer of the lubrication material is frozen.

The method may also include maintaining the self-supporting lubrication rings below the phase-change temperature within a cold storage.

The method may also include: removing a first of the self-supporting lubrication rings from the cold storage; arranging the first of the self-supporting lubrication rings with a bolt within an environment while the first of the self-supporting lubrication rings remains below the phase-change temperature, wherein the phase-change temperature is lower than an ambient temperature of the environment during the arranging of the first of the self-supporting lubrication rings, the bolt includes a head and a shank projecting axially out from the head to a distal end of the shank, and the arranging of the first of the self-supporting lubrication rings includes mounting the first of the self-supporting lubrication rings onto the shank and axially abutting the first of the self-supporting lubrication rings against the head; arranging the bolt with a first engine component and a second engine component such that the first of the self-supporting lubrication rings is axially between the head and the first engine component and the shank is disposed in a first aperture of the first engine component and a second aperture of the second engine component; and preloading the head against the first engine component axially through the lubrication material, wherein the lubrication material is at a temperature above the phase-change temperature during the preloading.

The method may also include: arranging the fastening member with a first component of an aircraft engine and a second component of the aircraft engine such that: (a) the lubrication material is axially between and contacts a head of the fastening member and the first component, the first component comprising the surface and the aperture; and (b) the shank is disposed in the aperture and a second aperture in the second component; and preloading the head against the first component axially through the lubrication material, wherein the lubrication material is at a second temperature, which is higher than the first temperature, such that the lubrication material is semi-solid prior to the preloading of the head.

The lubrication material may be at a third temperature prior to the arranging of the fastening member. The third temperature may be between the first temperature and the second temperature, and closer to the second temperature than the first temperature.

The lubrication material may be semi-solid at the third temperature.

The method may also include: threading a nut onto the shank with the first component and the second component captured axially between the head and the nut; and torquing the nut onto the fastening member to preload the head against the first component axially through the lubrication material.

The aircraft engine may be a gas turbine engine. The first component may be a first case of the gas turbine engine. The second component may be a second case of the gas turbine engine.

The method may also include controlling a temperature of the lubrication material to be below a phase-change temperature associated with the lubrication material. The lubrication material may be in a non-solid state when above the phase-change temperature and the lubrication material may be in a solid state when below the phase-change temperature.

The temperature of the lubrication material may be controlled to be below the phase-change temperature during a period of time leading up to the arranging of the lubrication material with the fastening member.

The lubrication material comprises a material selected from the following materials: a petroleum-based lubrication material; a molybdenum disulfide lubrication material; and grease.

The method may also include cutting the self-supporting lubrication ring out of a layer of the lubrication material at or below a phase-change temperature associated with the lubrication material. The lubrication material may be in a non-solid state when above the phase-change temperature and the lubrication material may be in a solid state when below the phase-change temperature.

The method may also include punching the self-supporting lubrication ring out of a layer of the lubrication material at or below a phase-change temperature associated with the lubrication material. The lubrication material may be in a non-solid state when above the phase-change temperature and the lubrication material may be in a solid state when below the phase-change temperature.

The lubrication material may be a petroleum-based lubrication material.

The lubrication material may include molybdenum disulfide.

The lubrication material may be grease.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic illustration of an aircraft powerplant.

FIG. 2 is a partial end view illustration of a stationary structure for the aircraft powerplant at a mechanical joint.

FIG. 3 is a partial sectional illustration of the stationary structure taken along section line 3-3 in FIG. 2.

FIG. 4 is a flow diagram of a method of manufacture.

FIG. 5 is a perspective illustration of a layer of lubrication material.

FIG. 6 is a perspective illustration of the layer of lubrication material with lubrication rings formed therefrom.

FIG. 7 is a sectional illustration of a bolt with a respective lubrication ring mounted on the bolt.

FIGS. 8 and 9 are sectional illustrations depicting steps for connecting engine components together.

### DETAILED DESCRIPTION

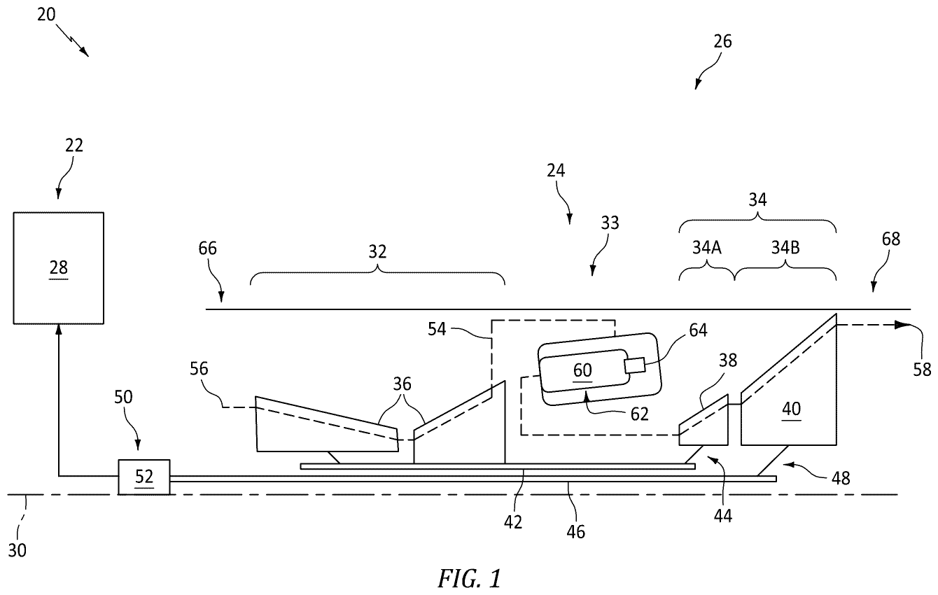

FIG. 1 illustrates a powerplant 20 for an aircraft. The aircraft may be a rotorcraft (e.g., a helicopter), an airplane, a drone (e.g., an unmanned aerial vehicle (UAV)) or any other manned or unmanned aerial vehicle or system. The powerplant 20 may be configured as, or otherwise included as part of, a propulsion and/or lift system for the aircraft. The powerplant 20 may also or alternatively be configured as, or otherwise included as part of, an electrical power system for the aircraft. The present disclosure, however, is not limited to aircraft applications. The powerplant 20, for example, may alternatively be configured as, or otherwise included as part of, an electrical power system for ground-based operation (e.g., an industrial powerplant), or otherwise. However, for ease of description, the powerplant 20 is described below as an aircraft powerplant.

The aircraft powerplant 20 of FIG. 1 includes a mechanical load 22 and a core 24 of a gas turbine engine 26, where the engine core 24 is configured to power operation of the mechanical load 22. The mechanical load 22 may be configured as or otherwise include a rotor 28 mechanically driven by the engine core 24. This driven rotor 28 may be a bladed propulsor rotor for the aircraft propulsion and/or lift system. The propulsor rotor may be an open propulsor rotor (e.g., an un-ducted propulsor rotor) or a ducted propulsor rotor. For example, where the gas turbine engine 26 is a turboshaft engine, the open propulsor rotor may be a rotorcraft rotor such as a helicopter main rotor or a helicopter tail rotor. Where the gas turbine engine 26 is a turboprop engine, the open propulsor rotor may be a propeller rotor. Where the gas turbine engine 26 is a turbofan engine, the ducted propulsor rotor may be a fan rotor. Alternatively, the driven rotor 28 may be configured as a generator rotor of an electric power generator for the aircraft electrical power system; e.g., an auxiliary power unit (APU) system. The present disclosure, however, is not limited to the foregoing exemplary mechanical loads nor to the foregoing exemplary gas turbine engines. The gas turbine engine 26, for example, may alternatively be configured as a turbojet engine, a propfan engine, a pusher fan engine or any other type of turbine engine operable to power the operation of the mechanical load 22. Moreover, while the gas turbine engine 26 is described below with a two-spool core, the present disclosure is not limited to such an exemplary arrangement.

The gas turbine engine 26 extends axially along an axis 30 from a forward, upstream end of the gas turbine engine 26 to an aft, downstream end of the gas turbine engine 26. Briefly, this axis 30 may be a centerline axis of the gas turbine engine 26 and/or its engine core 24. The axis 30 may also be a rotational axis of one or more members of the gas turbine engine 26 and its engine core 24. The gas turbine engine 26 of FIG. 1 includes a compressor section 32, a combustor section 33 and a turbine section 34. The turbine section 34 of FIG. 1 includes a high pressure turbine (HPT) section 34A and a low pressure turbine (LPT) section 34B, which LPT section 34B of FIG. 1 is a power turbine (PT) section for powering operation of the mechanical load 22.

The compressor section 32 includes a compressor rotor 36. The HPT section 34A includes a high pressure turbine (HPT) rotor 38. The LPT section 34B includes a low pressure turbine (LPT) rotor 40. The compressor rotor 36, the HPT rotor 38 and the LPT rotor 40 each respectively include one or more arrays (e.g., stages) of rotor blades, where the rotor blades in each array are arranged circumferentially around and are connected to a respective rotor disk or hub. The rotor blades in each array, for example, may be formed integral with or mechanically fastened, welded, brazed and/or otherwise attached to the respective rotor disk and/or hub.

The compressor rotor 36 is coupled to and rotatable with the HPT rotor 38. The compressor rotor 36 of FIG. 1, for example, is connected to the HPT rotor 38 by a high speed shaft 42. At least (or only) the compressor rotor 36, the HPT rotor 38 and the high speed shaft 42 collectively form a high speed rotating assembly 44; e.g., a high speed spool of the gas turbine engine 26. The LPT rotor 40 of FIG. 1 is connected to a low speed shaft 46. At least (or only) the LPT rotor 40 and the low speed shaft 46 collectively form a low speed rotating assembly 48; e.g., a low speed spool/a power turbine spool of the gas turbine engine 26. This low speed rotating assembly 48 is further coupled to the driven rotor 28 through a drivetrain 50. This drivetrain 50 may be configured as a geared drivetrain, where a geartrain 52 (e.g., a transmission, a speed change device, an epicyclic geartrain, etc.) is disposed between and operatively couples the driven rotor 28 to the low speed rotating assembly 48 and its LPT rotor 40. With this arrangement, the driven rotor 28 may rotate at a different (e.g., slower) rotational speed than the low speed rotating assembly 48 and its LPT rotor 40. However, the drivetrain 50 may alternatively be configured as a direct drive drivetrain, where the geartrain 52 is omitted. With such an arrangement, the driven rotor 28 may rotate at a common (the same) rotational speed as the low speed rotating assembly 48 and its LPT rotor 40. Referring again to FIG. 1, each of the rotating assemblies 44, 48 and its members may be rotatable about the axis 30, and the axis 30 may be a centerline axis of each of the rotating assemblies 44, 48 and its members.

The gas turbine engine 26 of FIG. 1 includes a (e.g., annular) core flowpath 54. The core flowpath 54 extends longitudinally within the gas turbine engine 26 and its engine core 24 from an airflow inlet 56 into the core flowpath 54 to a combustion products exhaust 58 from the core flowpath 54. More particularly, the core flowpath 54 extends from the core inlet 56, sequentially through the compressor section 32, the combustor section 33, the HPT section 34A and the LPT section 34B, to the core exhaust 58.

During operation of the gas turbine engine 26, air is directed into the engine core 24 through the core inlet 56. This air entering the core flowpath 54 may be referred to as “core air”. This core air is compressed by the compressor rotor 36 and directed into a combustion chamber 60 (e.g., an annular combustion chamber) within a combustor 62 (e.g., an annular combustor) of the combustor section 33. Fuel is injected into the combustion chamber 60 by one or more fuel injectors 64 and mixed with the compressed core air to provide a fuel-air mixture. This fuel-air mixture is ignited and combustion products thereof flow through and sequentially drive rotation of the HPT rotor 38 and the LPT rotor 40. The rotation of the HPT rotor 38 drives rotation of the compressor rotor 36 and, thus, the compression of the air received from the core inlet 56. The rotation of the LPT rotor 40 drives rotation of the driven rotor 28. Where the driven rotor 28 is configured as the propulsor rotor, the rotation of this propulsor rotor propels additional air (e.g., outside of the engine core 24 and its core flowpath 54) to provide aircraft thrust and/or aircraft lift. Where the driven rotor 28 is configured as the generator rotor, the rotation of this generator rotor may facilitate generation of electricity.

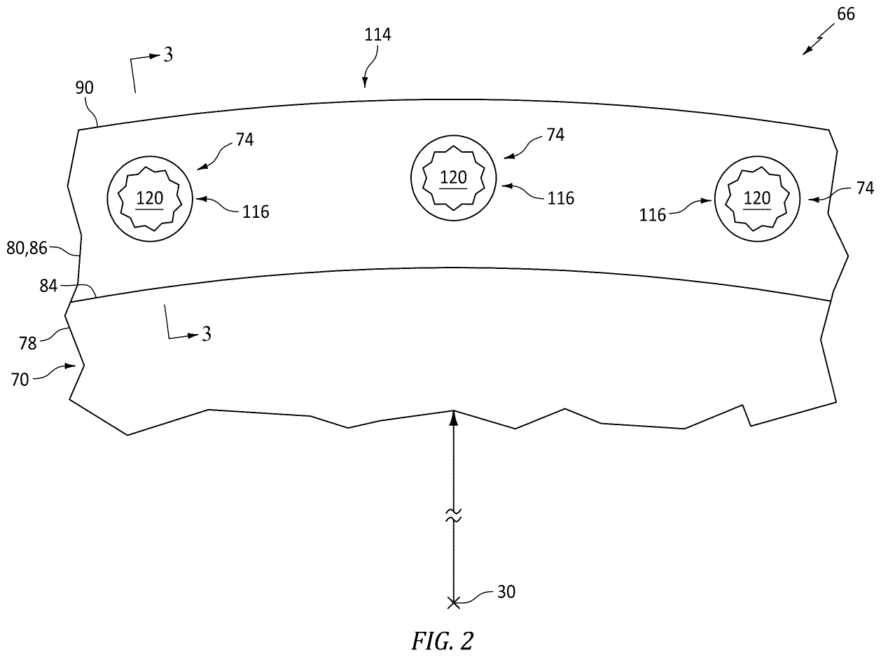

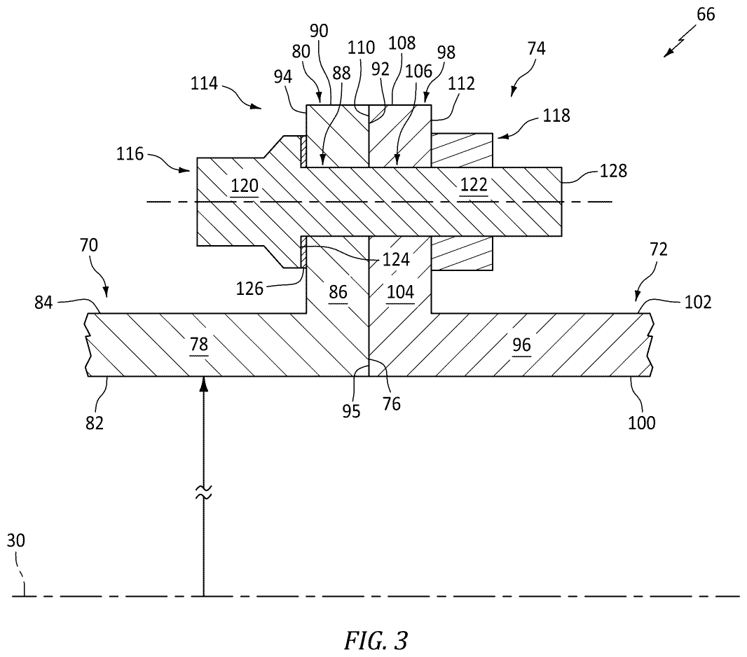

FIGS. 2 and 3 illustrate portions of a stationary structure 66 for the gas turbine engine. This stationary structure 66 may be configured to partially or completely house various components of the gas turbine engine 26 of FIG. 1. The stationary structure 66 of FIG. 1, for example, is configured as or otherwise includes an engine housing; e.g., an engine casing. For ease of description, the portions of the stationary structure 66 shown in FIGS. 2 and 3 are described below as housing one or more hot sections and/or hot section components of the gas turbine engine 26 and its engine core 24 of FIG. 1. Examples of the engine hot sections include, but are not limited to, the combustor section 33, the HPT section 34A, the LPT section 34B and an exhaust section 68. Examples of the hot section components include, but are not limited to, the combustor 62, the HPT rotor 38, the LPT rotor 40, vane array(s) and flowpath wall(s). The present disclosure, however, is not limited to such an exemplary arrangement. For example, the portions of the stationary structure 66 shown in FIGS. 2 and 3 may alternatively (or also) be configured as one or more components (e.g., frame(s), vane array(s), flowpath wall(s), etc.) disposed within one or more hot sections of the gas turbine engine 26 and its engine core 24.

The stationary structure 66 of FIGS. 2 and 3 includes a first engine component 70 and a second engine component 72. This stationary structure 66 also includes a plurality of fastener assemblies 74 for securing the first engine component 70 and the second engine component 72 together.

Referring to FIG. 3, the first engine component 70 may be configured as or otherwise include a tubular engine case and/or support structure. The first engine component 70 extends axially along the axis 30 to an axial end 76 of the first engine component 70. The first engine component 70 includes a first component base 78 and a first component mount 80.

The first component base 78 of FIG. 3 extends axially along the axis 30 to the first component mount 80. The first component base 78 extends radially from a radial inner side 82 of the first engine component 70 to a radial outer side 84 of the first component base 78. The first component base 78 extends circumferentially about (e.g., completely around) the axis 30, providing the first component base 78 with a full-hoop (e.g., tubular) geometry around the axis 30 for example.

The first component mount 80 is connected to (e.g., formed integrally with or otherwise attached to) the first component base 78. The first component mount 80 is disposed at (e.g., on, adjacent or proximate) the first component end 76. The first component mount 80 of FIG. 3 includes a first component flange 86 and one or more first component apertures 88.

The first component flange 86 of FIG. 3 is located at and may partially or completely define the first component end 76. The first component flange 86 projects radially outward from the radial inner side 82 of the first engine component 70 to a radial outer distal end 90 of the first component flange 86. The first component flange 86 extends axially along the axis 30 between and to opposing axial sides 92 and 94 of the first component flange 86. At the flange first side 92, the first component flange 86 may include an annular interior mating surface with, for example, a flat planar geometry perpendicular to the axis 30. At the flange second side 94, the first component flange 86 may include an annular exterior surface with, for example, a flat planar geometry perpendicular to the axis 30.

The first component apertures 88 are arranged circumferentially about the axis 30 in an array; e.g., a circular array. Each first component aperture 88 extends axially through the first component mount 80 and, more particularly, the first component flange 86 between the opposing axial sides 92 and 94 of the first component flange 86. Each first component aperture 88 of FIG. 3 may be configured as an unthreaded through-hole with, for example, a regular cylindrical geometry.

The second engine component 72 may be configured as or otherwise include a tubular engine case and/or support structure. The second engine component 72 extends axially along the axis 30 to an axial end 95 of the second engine component 72. The second engine component 72 includes a second component base 96 and a second component mount 98.

The second component base 96 of FIG. 3 extends axially along the axis 30 to the second component mount 98. The second component base 96 extends radially from a radial inner side 100 of the second engine component 72 to a radial outer side 102 of the second component base 96. The second component base 96 extends circumferentially about (e.g., completely around) the axis 30, providing the second component base 96 with a full-hoop (e.g., tubular) geometry around the axis 30 for example.

The second component mount 98 is connected to (e.g., formed integrally with or otherwise attached to) the second component base 96. The second component mount 98 is disposed at the second component end 95. The second component mount 98 of FIG. 3 includes a second component flange 104 and one or more second component apertures 106.

The second component flange 104 of FIG. 3 is located at and may partially or completely define the second component end 95. The second component flange 104 projects radially outward from the radial inner side 100 of the second engine component 72 to a radial outer distal end 108 of the second component flange 104. The second component flange 104 extends axially along the axis 30 between and to opposing axial sides 110 and 112 of the second component flange 104. At the flange first side 110, the second component flange 104 may include an annular interior mating surface with, for example, a flat planar geometry perpendicular to the axis 30. At the flange second side 112, the second component flange 104 may include an annular exterior surface with, for example, a flat planar geometry perpendicular to the axis 30.

The second component apertures 106 are arranged circumferentially about the axis 30 in an array; e.g., a circular array. A pattern of the second component apertures 106 in this array matches (e.g., is the same as, is identical to) a pattern of the first component apertures 88. Each second component aperture 106 extends axially through the second component mount 98 and, more particularly, the second component flange 104 between the opposing axial sides 110 and 112 of the second component flange 104. Each second component aperture 106 of FIG. 3 may be configured as an unthreaded through-hole with, for example, a regular cylindrical geometry.

The first engine component 70 and the second engine component 72 are arranged together at a mechanical joint 114. The second component mount 98, for example, may be axially translated along the axis 30 until the second component flange 104 axially engages the first component mount 80 and its first component flange 86. The second component interior mating surface, for example, may axially abut against, axially contact and/or otherwise axially engage the first component interior mating surface. Each first component aperture 88 of FIG. 3 is radially and circumferentially aligned with (e.g., coaxial with) a respective second component aperture 106.

Each fastener assembly 74 is mated with a respective set of the component fastener apertures 88 and 106 to secure the first engine component 70 and the second engine component 72 together. Each fastener assembly 74 of FIG. 3, for example, includes a bolt 116 (or another type of fastener member) and a nut 118. The bolt 116 of FIG. 3 includes a bolt head 120 and a bolt shank 122 connected to (e.g., formed integral with or otherwise attached to) the bolt head 120. An annular contact face 124 of the bolt head 120 is axially abutted against and/or otherwise axially engages the first component mount 80 and its first component flange 86 (or alternatively the second component mount 98 and its second component flange 104) through a thin layer of lubrication material 126; e.g., an anti-galling compound, a semi-solid lubricant, etc. The bolt shank 122 projects axially out from the bolt head 120, and extends sequentially through a respective first component aperture 88 and an aligned second component aperture 106, to a distal end 128 of the bolt 116 and its bolt shank 122. The nut 118 is mounted (e.g., threaded) onto the bolt shank 122 at its distal end 128 and tightened to axially capture and clamp the first component mount 80 and the second component mount 98 together between the bolt head 120 and the nut 118. The lubrication material 126 between the bolt head 120 and the first component mount 80 may (a) reduce or prevent damage to (e.g., galling of) the first component mount 80 and/or (b) reduce friction between the bolt head 120 and the first component mount 80 to facilitate accurate and repeatable torquing of the respective fastener assembly 74 and its members 116 and 118.

The lubrication material 126 may be a high temperature lubrication material selected for proximal use to the engine hot section(s) and/or engine hot section component(s) housed, supported and/or formed by the stationary structure 66. The lubrication material 126 may be selected to have a semi-solid state when the lubrication material 126 is at an ambient temperature in a typical gas turbine engine manufacturing environment. More particularly, the lubrication material 126 may be selected to have a semi-solid state when the lubrication material 126 is at a temperature at least between fifty degrees Fahrenheit (50° F.) and eighty degrees Fahrenheit (80° F.), inclusive. The lubrication material 126, for example, may be a petroleum-based lubrication material such as high temperature grease. An example of high temperature grease is a molybdenum sulfide grease, also sometimes referred to as moly grease. The lubrication material 126 of the present disclosure, however, is not limited to such exemplary materials nor temperature parameters.

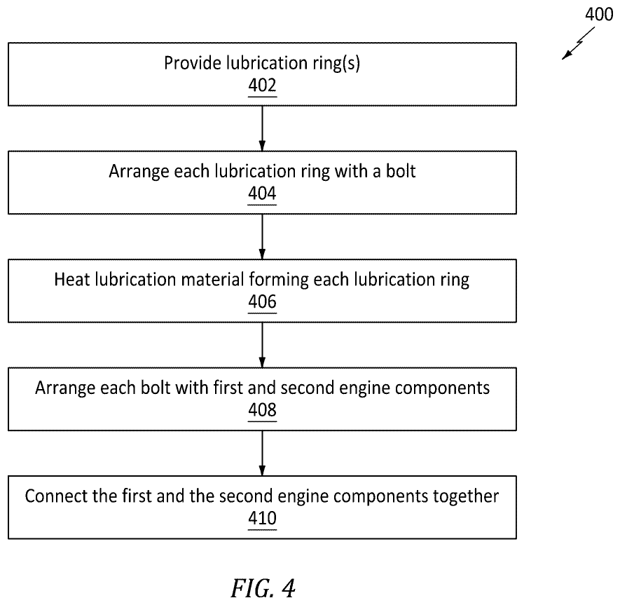

FIG. 4 is a flow diagram of a method 400 of manufacture. For ease of description, this manufacturing method 400 is described below with reference to the stationary structure 66 of FIGS. 2 and 3. The manufacturing method 400 of the present disclosure, however, is not limited to such an exemplary stationary structure. Moreover, the term “manufacture” is broadly used herein to cover methods where components such as the first engine component 70 and the second engine component 72 of FIGS. 2 and 3 are assembled together. For example, this manufacturing method 400 may be performed to assemble the stationary structure 66 during an original manufacturing process, a remanufacturing (e.g., repair) process and/or following an inspection process or the like.

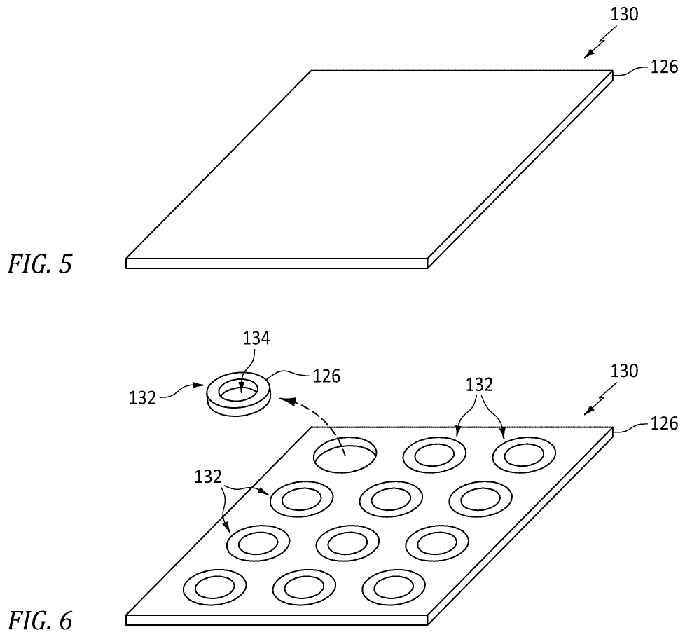

In step 402, one or more self-supporting lubrication rings are provided. For example, referring to FIG. 5, a quantity of the lubrication material 126 in a semi-solid state may be spread out into a lubrication material layer 130; e.g., a relatively thin sheet of the lubrication material 126 with a flat geometry and a uniform thickness. This lubrication material layer 130 may then be cooled (e.g., chilled) to a processing temperature at which the lubrication material 126 is a solid. The normally semi-solid lubrication material 126 (e.g., at ambient temperature) forming the lubrication material layer 130 may thereby be frozen such that the lubrication material 126 becomes structurally self-supporting; e.g., relatively stiff. Here, the processing temperature is equal to or below a phase-change temperature (e.g., a solidification temperature, a freezing temperature) of the lubrication material 126, which phase-change temperature is typically less than thirty-two degrees Fahrenheit (32° F.) or even less than zero degrees Fahrenheit (0° F.). When the lubrication material 126 is above the phase-change temperature, the lubrication material 126 is in a non-solid state (e.g., a liquid state). When lubrication material 126 is below the phase-change temperature, the lubrication material 126 is in a solid state. Referring to FIG. 6, the lubrication rings 132 may subsequently be formed out of the solid lubrication material layer 130. The lubrication rings 132, for example, may be cut out of the solid lubrication material layer 130 and/or punched (e.g., stamped) out of the solid lubrication material layer 130.

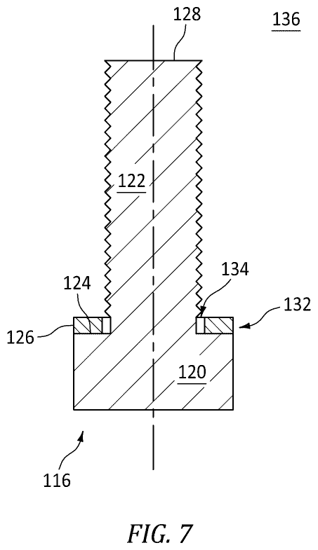

In step 404, referring to FIG. 7, a respective one of the lubrication rings 132 is arranged with each bolt 116. During this arrangement step 404, the lubrication ring 132 may be maintained in its solid state (e.g., at or about the processing temperature) such that the lubrication ring 132 remains self-supporting. To arrange the lubrication ring 132 with the bolt 116, the bolt end 128 may be passed through a bore 134 of the lubrication ring 132 to mount the lubrication ring 132 onto the bolt shank 122. The lubrication ring 132 may then be axially translated along the bolt shank 122 until the lubrication ring 132 is axially abutted against (e.g., resting on) the bolt head 120 and its contact face 124. Thus, the lubrication ring 132 may be handled and mounted onto the respective bolt 116 like a typical washer.

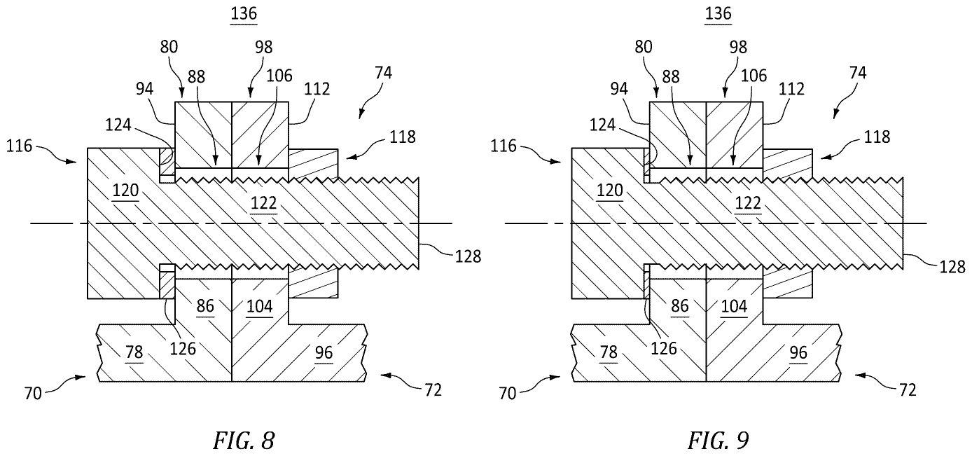

In step 406, the lubrication ring 132 mounted on each bolt 116 is heated to a handling temperature at which the lubrication material 126 is substantially or completely in its semi-solid state. This handling temperature may be colder than an ambient temperature of an environment 136 in which the first engine component 70 and the second engine component 72 (see FIG. 8) are assembled—an assembly temperature. However, the handling temperature may also be typically closer in value to the assembly temperature than the processing temperature. For example, the handling temperature may be up to (or at least) seventy percent (70%), eighty percent (80%) or ninety percent (90%) from the processing temperature to the assembly temperature. For example, whereas the processing temperature may be at least twenty-five degrees or fifty degrees colder than the assembly temperature, the processing temperature may be within five degrees, ten degrees or fifteen degrees of the assembly temperature. The foregoing temperatures, of course, may vary depending on the specific assembly environment 136 and/or the specific lubrication material 126 forming the lubrication ring 132. Moreover, it is contemplated the handling temperature may alternatively be equal to or even slightly greater than the assembly temperature depending on how the lubrication ring 132 is heated.

In some embodiments, the lubrication ring 132 may be passively heated by placing the lubrication ring 132 mounted on each bolt 116 in the assembly environment 136 (or a like environment) for a select period of time. In other embodiments, the lubrication ring 132 may be actively heated using a heat source for a select period of time.

In step 408, referring to FIG. 8, each bolt 116 with its lubrication material 126 is arranged with the first engine component 70 and the second engine component 72. The bolt end 128, for example, may be passed through the respective first component aperture 88 and the second component aperture 106. The bolt shank 122 may then be translated axially through the respective first component aperture 88 and the second component aperture 106 until the now semi-solid lubrication material 126 is axially between and contacts both the bolt head 120 and the first component mount 80.

In step 410, the first engine component 70 and the second engine component 72 are connected together. Each bolt 116, for example, is mated with its respective nut 118. The nut 118, for example, is threaded onto the bolt shank 122 to axially capture the first component mount 80 and the second component mount 98 axially between the bolt head 120 and the nut 118. Referring to FIG. 9, the nut 118 may then be tightened onto the bolt shank 122 to torque the fastener assembly 74 and its members 116 and 118 to specification. The bolt head 120 may thereby be axially preloaded against the first component mount 80 through the lubrication material 126. Prior to this preloading, the lubrication material 126 is in its semi-sold state. The lubrication material 126, for example, may remain substantially at the handling temperature or may be warmer (e.g., at the assembly temperature) due to continued exposure to the assembly environment 136. With the lubrication material 126 in its semi-sold state, the preloading may squeeze out some of the lubrication material 126 out from between the elements 80 and 120 to provide the (e.g., uniform) thin layer of the lubrication material 126 between the preloaded bolt head 120 and the first component mount 80.

With the foregoing process, the lubrication material 126 may be readily arranged with each bolt head 120 without, for example, inadvertently applying the lubrication material 126 onto the bolt shank 122. In addition, tolerance of the lubrication ring 132 may be set such that each bolt head 120 is provided with a uniform applied and precise amount of the lubrication material 126, in a repeatable fashion. By contrast, where lubrication material is applied to a bolt head as a paste using a brush, the brush may inadvertently brush against threads of a bolt shank. In addition, when applying lubrication material with a brush, the lubrication material may not be applied in a uniform and/or repeatable manner.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. A method, comprising:
arranging lubrication material with a fastening member, wherein the lubrication material is at a first temperature during the arranging of the lubrication material such that the lubrication material is solid and forms a self-supporting lubrication ring and the arranging of the lubrication material includes one of:
mounting the self-supporting lubrication ring onto a shank of the fastening member; or
mounting the self-supporting lubrication ring onto a surface defining an aperture such that the lubrication ring extends around the aperture; and
after the arranging of the lubrication material, inserting the shank of the fastening member into the aperture.

2. The method of claim 1, further comprising:
arranging the fastening member with a first component of an aircraft engine and a second component of the aircraft engine such that
the lubrication material is axially between and contacts a head of the fastening member and the first component, the first component comprising the surface and the aperture; and
the shank is disposed in the aperture and a second aperture in the second component; and
preloading the head against the first component axially through the lubrication material, wherein the lubrication material is at a second temperature, which is higher than the first temperature, such that the lubrication material is semi-solid prior to the preloading of the head.

3. The method of claim 2, wherein
the lubrication material is at a third temperature prior to the arranging of the fastening member; and
the third temperature is between the first temperature and the second temperature, and closer to the second temperature than the first temperature.

4. The method of claim 3, wherein the lubrication material is semi-solid at the third temperature.

5. The method of claim 2, further comprising:
threading a nut onto the shank with the first component and the second component captured axially between the head and the nut; and
torquing the nut onto the fastening member to preload the head against the first component axially through the lubrication material.

6. The method of claim 2, wherein
the aircraft engine is a gas turbine engine;
the first component is a first case of the gas turbine engine; and
the second component is a second case of the gas turbine engine.

7. The method of claim 1, further comprising controlling a temperature of the lubrication material to be below a phase-change temperature associated with the lubrication material, wherein the lubrication material is in a non-solid state when above the phase-change temperature and the lubrication material is in a solid state when below the phase-change temperature.

8. The method of claim 7, wherein the temperature of the lubrication material is controlled to be below the phase-change temperature during a period of time leading up to the arranging of the lubrication material with the fastening member.

9. The method of claim 7, wherein the lubrication material comprises a material selected from the following materials:
a petroleum-based lubrication material;
a molybdenum disulfide lubrication material; and
grease.

10. The method of claim 1, further comprising cutting the self-supporting lubrication ring out of a layer of the lubrication material at or below a phase-change temperature associated with the lubrication material, wherein the lubrication material is in a non-solid state when above the phase-change temperature and the lubrication material is in a solid state when below the phase-change temperature.

11. The method of claim 1, further comprising punching the self-supporting lubrication ring out of a layer of the lubrication material at or below a phase-change temperature associated with the lubrication material, wherein the lubrication material is in a non-solid state when above the phase-change temperature and the lubrication material is in a solid state when below the phase-change temperature.

12. The method of claim 1, wherein the lubrication material is a petroleum-based lubrication material.

13. The method of claim 1, wherein the lubrication material comprises molybdenum disulfide.

14. The method of claim 1, wherein the lubrication material comprises grease.

15. A method, comprising:
controlling a temperature of a layer of lubrication material to be below a phase-change temperature associated with the lubrication material, wherein the lubrication material is in a non-solid state when above the phase-change temperature and the lubrication material is in a solid state when below the phase-change temperature;
cutting a plurality of self-supporting lubrication rings out of the layer of lubrication material while the layer of lubrication material is below the phase-change temperature; and
gathering the plurality of self-supporting lubrication rings for further use while the plurality of self-supporting lubrication remains below the phase-change temperature.

16. The method of claim 15, further comprising maintaining the plurality of self-supporting lubrication rings below the phase-change temperature within a cold storage.

17. The method of claim 16, further comprising:
removing a first of the plurality of self-supporting lubrication rings from the cold storage;
arranging the first of the plurality of self-supporting lubrication rings with a bolt within an environment while the first of the plurality of self-supporting lubrication rings remains below the phase-change temperature, wherein the phase-change temperature is lower than an ambient temperature of the environment during the arranging of the first of the plurality of self-supporting lubrication rings, the bolt includes a head and a shank projecting axially out from the head to a distal end of the shank, and the arranging of the first of the plurality of self-supporting lubrication rings includes mounting the first of the plurality of self-supporting lubrication rings onto the shank and axially abutting the first of the plurality of self-supporting lubrication rings against the head;
arranging the bolt with a first engine component and a second engine component such that the first of the plurality of self-supporting lubrication rings is axially between the head and the first engine component and the shank is disposed in a first aperture of the first engine component and a second aperture of the second engine component; and
preloading the head against the first engine component axially through the lubrication material, wherein the lubrication material is at a temperature above the phase-change temperature during the preloading.

18. A method of manufacture, comprising:
forming a self-supporting lubrication ring out of a layer of lubrication material at or below a first temperature, wherein the lubrication material is solid at the first temperature;
mounting the self-supporting lubrication ring onto a shank of a bolt and axially abutting the self-supporting lubrication ring against a head of the bolt while the lubrication material is at the first temperature;
arranging the bolt with a first engine component and a second engine component such that the lubrication material is axially between the head of the bolt and the first engine component and the shank of the bolt is disposed in a first aperture of the first engine component and a second aperture of the second engine component; and
preloading the head of the bolt against the first engine component axially through the lubrication material, wherein the lubrication material is at a second temperature that is higher than the first temperature during the preloading of the head of the bolt, and the lubrication material is semi-solid at the second temperature.

19. The method of claim 18, further comprising:
threading a nut onto the shank of the bolt with the first engine component and the second engine component captured axially between the head of the bolt and the nut; and
torquing the nut onto the bolt to preload the head of the bolt against the first engine component axially through the lubrication material.

20. The method of claim 18, wherein the self-supporting lubrication ring is formed while the layer of the lubrication material is frozen.
